(19) United States
(12) Patent Application Publication
(10) Pub. No.: US 2011/0151093 A1
(43) Pub. Date: Jun. 23, 2011

(54) USES OF BRAN FROM TANNIN AND BLACK SORGHUM AS A COCOA EXTENDER AND NATURAL COLORANT

(75) Inventors: David Guarjardo-Flores, Guadalupe (MX); Llyod W. Rooney, Bryan, TX (US)

(73) Assignee: The Texas A&M University System

(21) Appl. No.: 12/951,892

(22) Filed: Nov. 22, 2010

Related U.S. Application Data
(60) Provisional application No. 61/264,008, filed on Nov. 24, 2009.

(51) Int. Cl. A21D 13/08; A23G 9/00; A23C 9/00; A23G 1/00; A23L 1/32; A23G 1/48

(52) U.S. Cl. 426/556; 426/565; 426/580; 426/593; 426/614; 426/618

(57) ABSTRACT

The present invention contemplates a formulation comprising an amount by weight of cocoa and an amount by weight of a sorghum bran-based cocoa extender wherein the bran fraction is selected from non-tannin sorghum, low tannin sorghum, high tannin sorghum, black sorghum, black tannin sorghum and mixtures thereof. In one embodiment, the present invention contemplates a method of preparing a foodstuff comprising a sorghum bran-based cocoa extender by providing a sorghum grain, removing the bran fraction from the sorghum grain, grinding the bran fraction and adding a desired amount of the bran fraction to a cocoa-containing foodstuff In another embodiment, the present invention contemplates a method of preparing a foodstuff comprising a sorghum bran-based cocoa extender by providing a recipe for a cocoa-containing foodstuff that specifies an amount of cocoa, ingredients for preparing the foodstuff that include cocoa, and a bran fraction of sorghum grain and preparing the cocoa-containing foodstuff by replacing a portion of the cocoa specified in the recipe with the bran fraction.

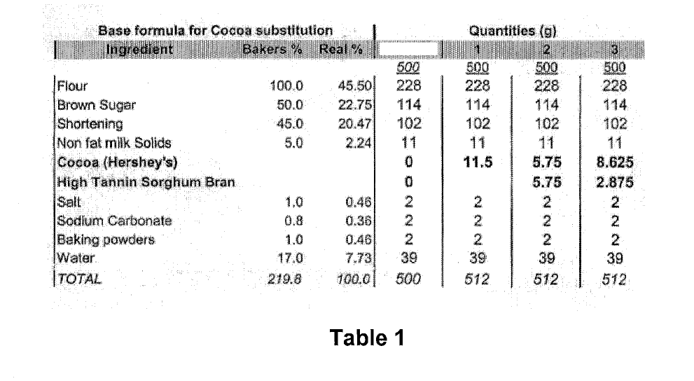

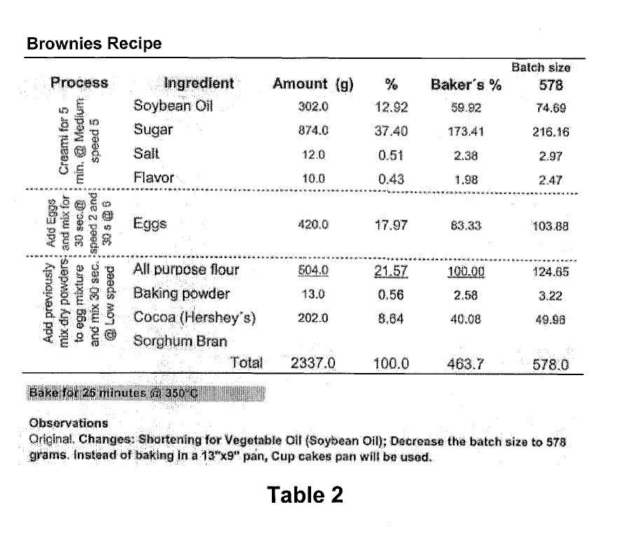

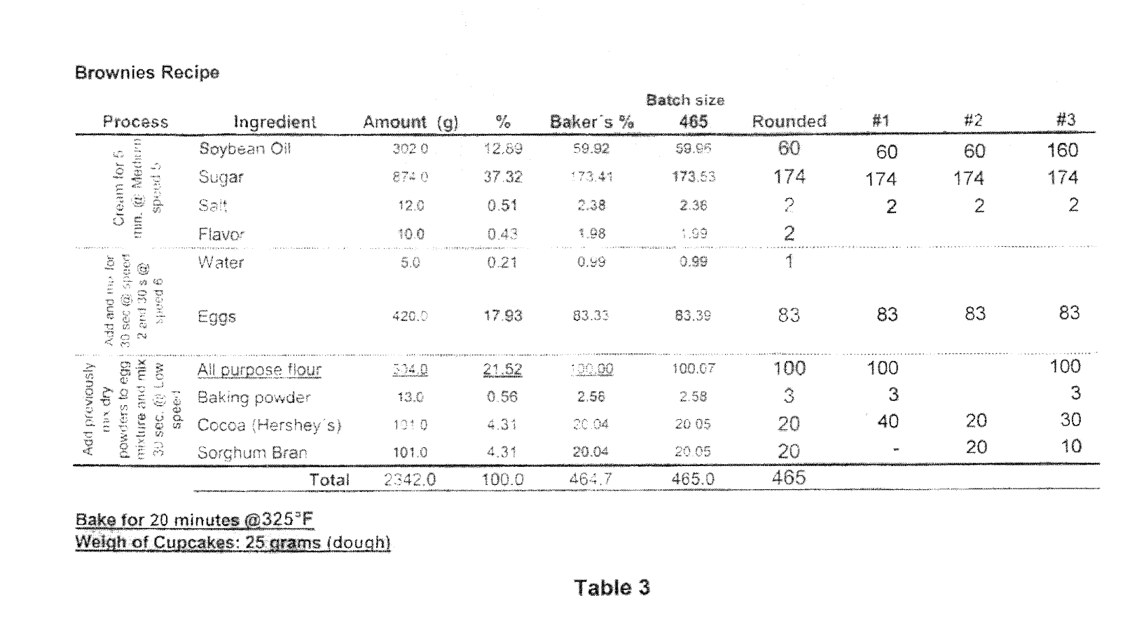

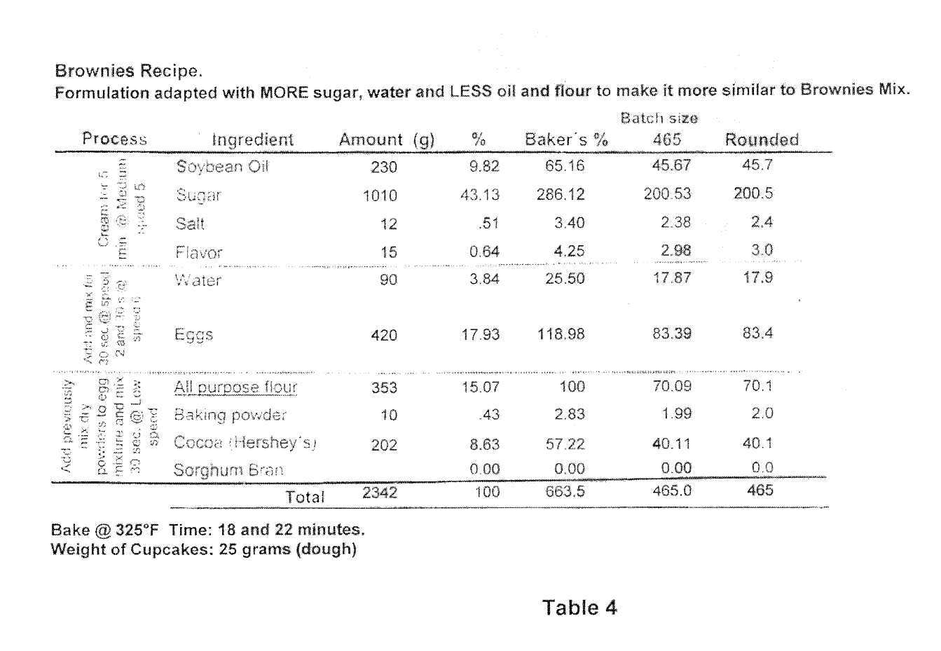

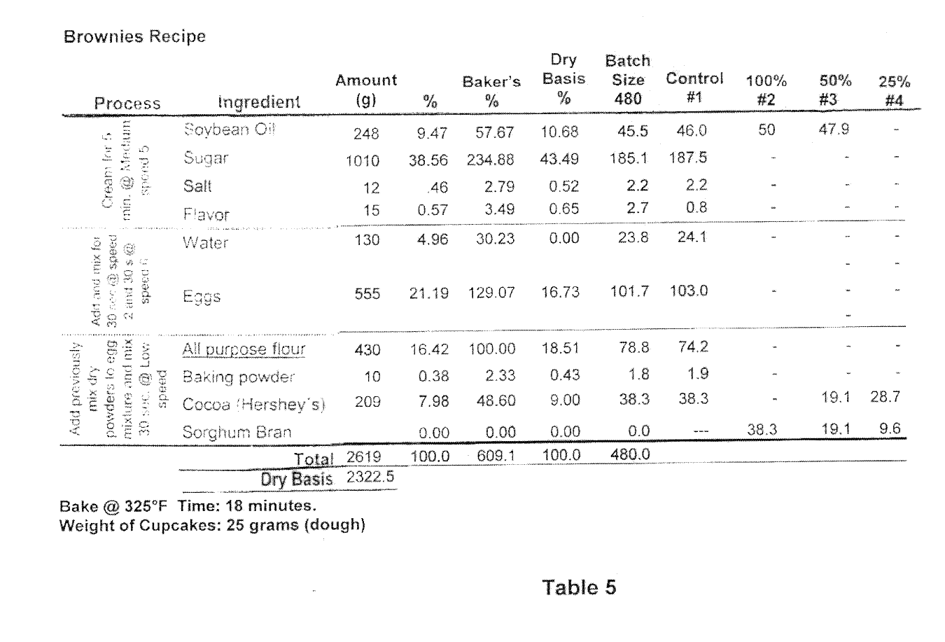

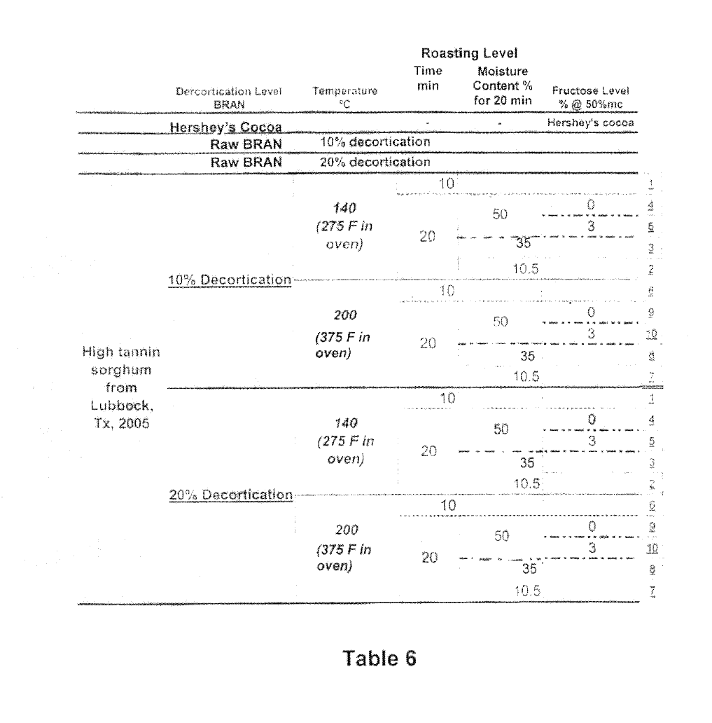

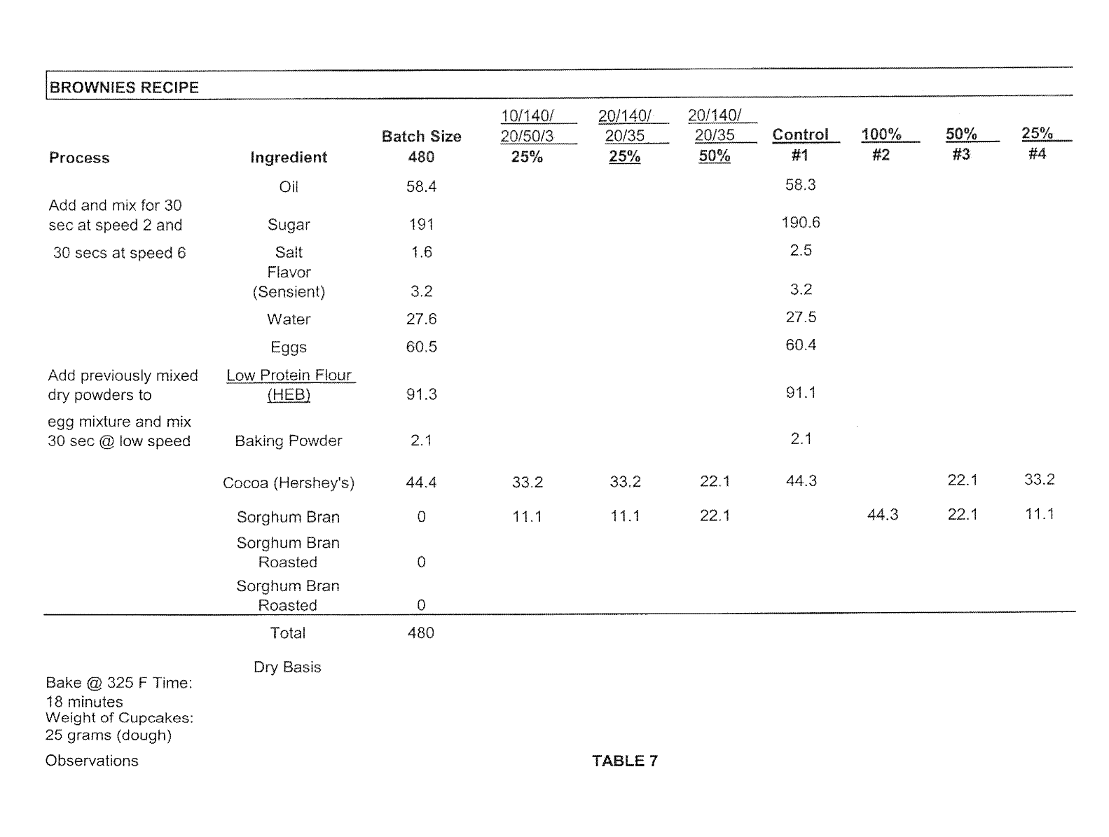

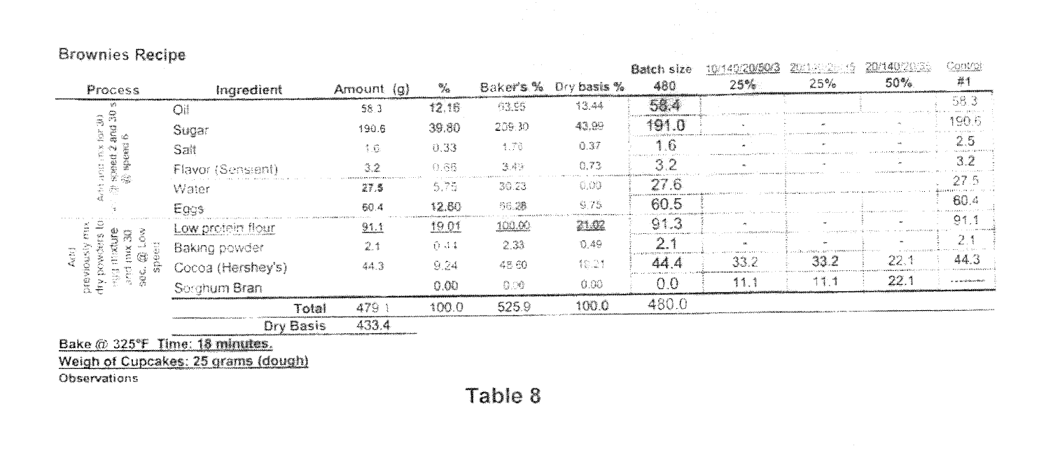

### STATEMENT OF GOVERNMENT SUPPORT

This invention was made with government support awarded by the USDA-ARS (grant number 58-5430-4-364). The government has certain rights in the invention.

### FIELD OF THE INVENTION

The present invention relates generally to a formulation comprising an amount by weight of cocoa and an amount by weight of a sorghum bran-based cocoa extender. In further embodiments, this invention relates to methods of preparing a foodstuff comprising a sorghum bran-based cocoa extender.

### BACKGROUND

Cocoa is a commonly used ingredient in many food products, such as cookies, brownies, pudding, chocolate, chocolate coatings and chocolate fillings. Due to high demand worldwide and fluctuations in market value, cocoa is recognized as an expensive ingredient. To reduce the overall cost of production, many cocoa-containing foodstuffs use cocoa substitutes (i.e. cocoa, extenders) to limit the amount of cocoa required. Commonly used cocoa substitutes in baking include roasted barley malt, carob bean pods and chicory root. While these substitutes are relatively inexpensive, some have an off-flavor that prevents significant substitution without affecting food product's taste and/or are not widely available. What is needed is a widely available and inexpensive cocoa extender with a mild flavor that permits significant levels of substitution without negatively affecting the taste of the food product.

### SUMMARY OF THE INVENTION

The present invention relates generally to a formulation comprising from a desired amount of cocoa and a desired amount of a sorghum bran-based cocoa extender. In further embodiments, this invention relates to methods of preparing a foodstuff comprising a sorghum bran-based cocoa extender.

In some embodiments, the present invention relates generally to a formulation comprising an amount by weight of cocoa and an amount by weight of sorghum-bran based cocoa extender, wherein the bran fraction of said sorghum bran-based cocoa extender is from the group consisting of non-tannin sorghum, low tannin sorghum, high tannin sorghum, black sorghum, black tannin sorghum and mixtures thereof In one embodiment, the formulation comprises from 75% to 50% by weight of cocoa and from 25% to 50% by weight of sorghum bran-based cocoa extender. In some embodiments, cocoa powder and cocoa extender may be combined in proportions ranging from 1:99 to 99:1. In some embodiments, cocoa extender may be substituted for any part of, or to the total exclusion of, the cocoa powder in foodstuffs utilizing cocoa and/or chocolate. In some embodiments the sorghum bran-based cocoa extender comprises a natural pigmentation. In some embodiments, roasting may alter the grade of said pigmentation. In other embodiments, the natural pigmentation enhances the color of a cocoa-containing foodstuff In other embodiments, the cocoa-containing foodstuff is selected from the group consisting of cocoa, chocolate, chocolate coatings, chocolate fillings, cookies, puddings, breads, beverages, baked goods, brownies, dairy products, ice cream, yogurt, tapioca, egg nog, candies, confections, coatings and syrups. In other embodiments, the foodstuff is a processed food. In still other embodiments, the sorghum bran-based cocoa extender is a source of dietary fiber. In further embodiments the dietary fiber is insoluble dietary fiber. In other embodiments, the sorghum bran-based cocoa extender is a component of a gluten-free foodstuff In yet other embodiments, the sorghum bran-based cocoa extender is a component of a diet for treating type-II diabetes. In some embodiments, sorghum bran substitution slows the digestion of starches in foodstuffs. In some embodiments, substitution with sorghum bran improves foodstuffs for diabetics because the foodstuffs are digested more slowly. In yet other embodiments, the sorghum bran-based cocoa extender is a component of a gluten free diet. In yet other embodiments, the sorghum bran-based cocoa extender is a component of a diet for treating and/or preventing cancer, such as colon cancer.

In some embodiments, the present invention relates generally to a method of preparing a foodstuff containing a sorghum bran-based cocoa extender comprising: providing a sorghum grain; removing the bran fraction from the sorghum grain; grinding the bran fraction; and adding the desired amount of the bran fraction to a cocoa-containing foodstuff so as to create a sorghum bran-based cocoa extender. In other embodiments, the sorghum grain is non-tannin sorghum, low tannin sorghum, high tannin sorghum, black sorghum, black tannin sorghum and mixtures thereof. In other embodiments, the bran fraction comprises a natural pigmentation. In further embodiments, adding the desired amount of the bran fraction to a cocoa-containing foodstuff alters the color of the foodstuff. In still further embodiments, the method further comprises roasting the bran fraction to alter the grade of the pigment of said bran fraction. In some embodiments, the bran fraction is roasted at a temperature between 140° C. to 200° C. for between 10 to 20 minutes. In some embodiments, adding the bran fraction to a cocoa-containing foodstuff replaces an equivalent amount of cocoa in said foodstuff. In other embodiments, from 25% to 50% by weight of cocoa is replaced by the bran fraction in a foodstuff. In still other embodiments, the natural pigmentation enhances the color of a cocoa-containing foodstuff such as cocoa, chocolate, chocolate coatings, chocolate fillings, cookies, puddings, breads, beverages, baked goods, brownies, dairy products, ice cream, yogurt, tapioca, egg nog, candies, confections, coatings and syrups. In still other embodiments, the sorghum bran-based cocoa extender is a source of dietary fiber. In further embodiments the dietary fiber is insoluble dietary fiber. In other embodiments, the sorghum bran-based cocoa extender is a component of a gluten-free foodstuff. In yet other embodiments, the sorghum bran-based cocoa extender is a component of a diet for treating type-II diabetes. In yet other embodiments, the sorghum bran-based cocoa extender is a component of a gluten free diet. In yet other embodiments, the sorghum bran-based cocoa extender is a component of a diet for treating and/or preventing cancer, such as colon cancer. In other embodiments, the sorghum bran-based cocoa extender contributes antifungal and/or antibacterial properties to a foodstuff.

In some embodiments, the present invention relates generally to a method of preparing a foodstuff comprising a sorghum bran-based cocoa extender comprising: providing: a recipe for a cocoa-containing foodstuff specifying an amount of cocoa; ingredients for preparing the foodstuff, said ingredients comprising cocoa; and a bran fraction of sorghum grain; replacing a portion of said amount of cocoa specified in said recipe with said bran fraction; and preparing said cocoa-containing foodstuff. In other embodiments, the ingredients further comprise flour. In other embodiments, the foodstuff is a baked good. In still other embodiments, the foodstuff is a beverage.

In some embodiments, the present invention relates generally to a formulation comprising an amount by weight of cocoa and an amount by weight of sorghum whole grain-based cocoa extender, wherein the bran component of said sorghum whole grain-based cocoa extender is from the group consisting of non-tannin sorghum, low tannin sorghum, high tannin sorghum, black sorghum, black tannin sorghum and mixtures thereof. In one embodiment, the formulation comprises from 75% to 50% by weight of cocoa and from 25% to 50% by weight of sorghum whole grain-based cocoa extender. In some embodiments the sorghum whole grain-based cocoa extender comprises a natural pigmentation. In some embodiments, roasting may alter the grade of said pigmentation. In other embodiments, the natural pigmentation enhances the color of a cocoa-containing foodstuff. In other embodiments, the cocoa-containing foodstuff is selected from the group consisting of cocoa, chocolate, chocolate coatings, chocolate fillings, cookies, puddings, breads, beverages, baked goods, brownies, dairy products, ice cream, yogurt, tapioca, egg nog, candies, confections, coatings and syrups. In still other embodiments, the sorghum whole grain-based cocoa extender is a source of dietary fiber. In further embodiments the dietary fiber is insoluble dietary fiber. In other embodiments, the sorghum whole grain-based cocoa extender is a component of a gluten-free foodstuff. In yet other embodiments, the sorghum whole grain-based cocoa extender is a component of a diet for treating type-II diabetes. In some embodiments, sorghum whole grain substitution slows the digestion of starches in foodstuffs. In some embodiments, substitution with sorghum whole grain improves foodstuffs for diabetics because the foodstuffs are digested more slowly. In yet other embodiments, the sorghum whole grain-based cocoa extender is a component of a gluten free diet. In yet other embodiments, the sorghum whole grain-based cocoa extender is a component of a diet for treating and/or preventing cancer, such as colon cancer.

In some embodiments, the present invention relates generally to a method of preparing a foodstuff containing a sorghum whole grain-based cocoa extender comprising: providing a sorghum grain; grinding the sorghum whole grain; and adding the desired amount of the ground sorghum whole grain to a cocoa-containing foodstuff so as to create a sorghum whole grain-based cocoa extender. In other embodiments, the bran component of the sorghum whole grain comprises non-tannin sorghum, low tannin sorghum, high tannin sorghum, black sorghum, black tannin sorghum and mixtures thereof. In other embodiments, the sorghum whole grain-based cocoa extender comprises a natural pigmentation. In further embodiments, adding the desired amount of the sorghum whole grain-based cocoa extender to a cocoa-containing foodstuff alters the color of the foodstuff In still further embodiments, the method further comprises roasting the sorghum whole grain-based cocoa extender to alter the grade of the pigment of said sorghum whole grain-based cocoa extender. In some embodiments, the sorghum whole grain-based cocoa extender is roasted at a temperature between 140° C. to 200° C. for between 10 to 20 minutes. In some embodiments, adding the sorghum whole grain-based cocoa extender to a cocoa-containing foodstuff replaces an equivalent amount of cocoa in said foodstuff In other embodiments, from 25% to 50% by weight of cocoa is replaced by the sorghum whole grain-based cocoa extender in a foodstuff In still other embodiments, the natural pigmentation enhances the color of a cocoa-containing foodstuff such as cocoa, chocolate, chocolate coatings, chocolate fillings, cookies, puddings, breads, beverages, baked goods, brownies, dairy products, ice cream, yogurt, tapioca, egg nog, candies, confections, coatings and syrups. In still other embodiments, the sorghum whole grain-based cocoa extender is a source of dietary fiber. In further embodiments the dietary fiber is insoluble dietary fiber. In other embodiments, the sorghum whole grain-based cocoa extender is a component of a gluten-free foodstuff. In yet other embodiments, the sorghum whole grain-based cocoa extender is a component of a diet for treating type-II diabetes. In yet other embodiments, the sorghum whole grain-based cocoa extender is a component of a gluten free diet. In yet other embodiments, the sorghum whole grain-based cocoa extender is a component of a diet for treating and/or preventing cancer, such as colon cancer. In other embodiments, the sorghum whole grain-based cocoa extender contributes antifungal and/or antibacterial properties to a foodstuff.

In some embodiments, the present invention relates generally to a method of preparing a foodstuff comprising a sorghum whole grain-based cocoa extender comprising: providing: a recipe for a cocoa-containing foodstuff specifying an amount of cocoa; ingredients for preparing the foodstuff, said ingredients comprising cocoa; and a sorghum whole grain fraction; replacing a portion of said amount of cocoa specified in said recipe with said sorghum whole grain fraction; and preparing said cocoa-containing foodstuff. In other embodiments, the ingredients further comprise flour. In other embodiments, the foodstuff is a baked good. In still other embodiments, the foodstuff is a beverage.

### DEFINITIONS

To facilitate the understanding of this invention a number of terms are defined below. Terms defined herein (unless otherwise specified) have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

As used herein, terms defined in the singular are intended to include those terms defined in the plural and vice versa.

As used herein, the term “sorghum” refers to a genus of numerous species of annual cereal grasses having broad leaves and a tall, pithy stem bearing the grain in a dense terminal cluster. Sorghum is extremely drought tolerant, and therefore well suited to growth in arid and dry areas making it a very stable source of nutrition as a result. The grain is neutral, and sometimes slightly sweet, in flavor. While sorghum may be eaten plain, the ability to absorb flavors allows it to be adapted to a variety of dishes. Sorghum is very high in fiber, iron and protein, with the majority of the nutrients retained in the grain's outer hull. Sorghum kernels are about 0.66 the weight of wheat grains, with the weight of 1000 sorghum grains generally between 20 and 30 grams. The sorghum grain consists of about 6 percent bran (the pericarp or surface layers); 10 percent germ; and 84 percent endosperm, which is largely starch. The protein content of sorghum is higher than corn and about equal to wheat. The fat content of sorghum is lower than corn but higher than wheat. Much of the sorghum currently grown in the United States is from hybrid seeds derived from isolated male sterile strains. Planting of a male-sterile line alongside suitable sorghum lines with fertile pollen result in the production of hybrid seed produced on the male-sterile line. Sorghum comes in many colors, including white, lemon-yellow, red, and black as well as secondary colors tan and purple. The R and Y genes control pericarp color while the P and Q genes control secondary color. The combination of the R and Y genes can produce white or colorless pericarp (R_yy or rryy), lemon-yellow pericarp (rrY_) and red or black pericarp (R_Y_). Combinations of the P and Q genes give rise to the secondary colors tan (ppqq or ppQQ) and purple (PPqq or PPQQ), and can range from very light to very dark. These color combinations include WT (White with tan secondary color); LYT (lemon-yellow with tan secondary color); LYP (lemon-yellow with purple secondary color); RdT (red with tan secondary color); RdP (red with purple secondary color); and BL (Black with purple secondary color). Non-grain sorghum tissues include the stalks, sheaths (the thin covering surrounding the stalks), glumes (the covering on the grains) and leaves. These tissues constitute a greater portion of the total biomass of a sorghum plant than the grain and represent a source of bioactive compounds between 78-170 times more than grains depending on variety. Typical hybrid sorghum in the United States has 40-50% of its dry weight in the grain and 5-10% of its dry weight in the leaves. Biomass sorghum yields about 2.8-4.5% panicle, the rest are leaves, stalks and debris.

As used herein, the terms “tannin” or “tannins” refers to a plant polyphenol that is only present in sorghums with a pigmented testa layer. Tannins are chemically classified in two main groups, “hydrolysable tannins” that are capable of being cleaved by hydrolysis, and “condensed tannins” that are not susceptible to cleavage by hydrolysis. Condensed tannins, sometimes referred to as non-hydrolysable tannins and/or proanthocyanidins, are polymers of 2 to 50 (or more) flavonoid units that are joined by carbon-carbon bonds. The tannin content of sorghum grain is influenced by the extent of pigmented testa in the grain—tannins are only present in sorghums that contain a pigmented testa. Thus, sorghums that lack a pigmented testa do not contain tannins. Type-III sorghums have more tannins than type-II sorghums, whereas type-I sorghums do not contain tannins. The B₁ and B₂ genes control the presence of the testa layer; a pigmented testa is present when the B₁ and B₂ genes are dominant. The S gene (spreader gene) indicates the presence of tannins; when the S gene is present tannins are present, and when the S gene is absent tannins are absent. As indicated below, a dominant spreader gene (indicated by a capitol “S”) indicates high levels of tannins, while low levels of tannins are indicated by a lowercase “s”. The term “high tannin sorghums” (B₁B₂_{_{—}}Ss) refers to sorghums that contain high levels of condensed tannins. The term “low tannin sorghums” (B₁B₂_{_{—}}ss) refers to sorghums that contain lower levels of condensed tannins. The term “non-tannin sorghum” (b₁b₁B₂_{_{—}}) and (B₁_{_{—}}b₂b₂) refers to sorghums that do not contain condensed tannins. “Black sorghum” refers to sorghum that has a black pericarp without a pigmented testa, while “black tannin sorghum” refers to a sorghum that has a black pericarp with a pigmented testa. Many foods such as grapes, blueberries, cranberries, dark chocolate, and carobs have condensed tannins. These foodstuffs are consumed without adverse effects and are considered to be health foods because of the antioxidant properties of the tannins. Although sorghums without a pigmented testa do not contain tannins, they may contain other non-tannin materials that absorb light and therefore exhibit characteristic colors. Thus for example, “black sorghum” lacks a pigmented testa but may nonetheless exhibit a blackish/brown color (i.e. chocolate color) due to such non-tannin materials. Grain color is not a reliable indicator of tannins in sorghum. Sorghums with a white, red, or lemon yellow pericarp may or may not contain tannins. A sorghum grain with a pigmented testa that contains condensed tannins is not necessarily visually distinguishable from a grain that does not contain a pigmented testa. For example, “white sorghum” does not contain a pigmented testa and does not exhibit a blackish/brown color; “white sorghum” may however exhibit a range of secondary colors other than white (such as purple) under a variety of conditions, such as following abrasion of the outer husk. In addition to the grain, tannins may also be found at various levels in other sorghum tissues, such tannin containing non-grain sorghum tissues that may include the stalks, sheaths, glumes and leaves.

As used herein, the term “testa” or “pigmented testa”, refers to a distinct layer in a sorghum kernel. The sorghum kernel is divided into three main components: seed coat, endosperm and embryo (or germ). The seed coat is further divided into two subcomponents—the pericarp and testa. The pericarp is typically divided into three to four sub-layers. The sequence of layers from seed surface to testa is as follows: epicarp, mesocarp, cross-cell layers and tube-cell layers. The epicarp is further subdivided into epidermis and hypodermis. Depending on genetic background, the epidermis may also contain pigments. The layer immediately below the pericarp and around the aleurone is called the testa. The testa layer is complete in some sorghum grains and partial or totally absent in others. The thickness of the testa layer may also vary.

As used herein, the term “phenol”, “phenolics” or “phenolic compounds” refers to a group of chemical compounds known as polyphenolics that affect the taste, color and mouthfeel of a variety of plants and fruits. Phenolic compounds can be broadly separated into flavonoid and non-flavonoid categories. Flavonoids include anthocyanins and tannins that contribute to the color and mouthfeel of foodstuffs. Non-flavonoids include stilbenes such as resveratrol and compounds derived from acids including benzoic, caffeic and cinnamic acid. Most phenols are classified as secondary metabolites and are not active in the primary metabolism and function of the sorghum plant. Phenolic compounds are a desirable component of nutraceuticals and functional foods, particularly as dietary antioxidants. While all sorghums contain phenolic compounds, the genotype and the environmental factors under which the grain matures influence the amount present in any particular cultivar.

As used herein, the term “cultivar” refers to a cultivated plant that has been selected for and given a unique name due to a desired characteristic. Typically that characteristic is distinct from similar plants and is retained following propagation.

As used herein, the term “flavonoids” refers to a class of plant secondary metabolites that are most commonly known for their antioxidant activity. Flavonoids are the most common group of polyphenolic compounds in the human diet and are found ubiquitously in plants as pigments (yellow or red/blue), signaling molecules, and repellents. The metabolic pathway of flavonoid continues through a series of enzymatic modifications to yield flavanones, dihydroflavonols, and ultimately anthocyanins. Sorghum contains a wide variety of flavonoids including 3-deoxyanthocyanins, flavones (such as the apigenin and luteolin), and flavanones (such as eriodictyol and naringenin). Other sources of flavonoids include citrus fruits, berries and cocoa.

As used herein, the term “procyanidin” refers to a subclass of flavonoids found in many plants, including both cocoa and sorghum, with known antioxidant activity.

As used herein, the term “anthocyanins” refers to water-soluble vacuolar pigments whose color (including red, purple, or blue) varies according to pH. Anthocyanins belong to a class of molecules called flavonoids and occur in all tissues of higher plants, including leaves, stems, roots, flowers and fruits. Anthocyanins act as powerful antioxidants and their synthesis often coincides with the synthesis of phenolic compounds. Anthocyanins are sugar-free derivatives of the plant pigment anthocyanidins.

As used herein, the term “flavone” refers to a plant pigment that is a subset of flavonoids. The major flavones in sorghum are the 3-deoxyanthocyanins apigenin and luteolin, which produce yellow and orange colors, respectively, in acidic solvents. These are different from the anthocyanins, which are mostly reddish to purple in acidic media. Apigenin and luteolin are therefore useful as replacements for artificial yellow and orange pigments.

As used herein, the term “flavanone” refers to any of various aromatic ketones derived from flavones, including naringenin and eriodictyol. Sorghum flavones and flavanones are located in the pericarp, where they are concentrated 4-9-fold in the bran.

As used herein, “secondary metabolites” are organic compounds that are not directly involved in normal growth, development, or reproduction. Unlike primary metabolites, the absence of secondary metabolites does not result in immediate death, but rather in long-term impairment of survivability, fecundity or aesthetics.

As used herein, the term “bran” refers to the hard outer layer of the grain and consists of the combined aleurone and pericarp. Bran is an integral part of whole grains and is often produced as a by-product of milling in the production of refined grains, including sorghum. When bran is removed from grains, the latter lose a portion of their nutritional value. Bran is particularly rich in dietary fiber and omegas and contains significant quantities of starch, protein, vitamins, and dietary minerals. The bran fraction of sorghum (sorghum bran) is a concentrated with antioxidants, procyanidins and condensed tannins.

As used herein, the term “whole grain” refers to cereal grains (including sorghum) in which both the bran fraction, the germ and the endosperm are present. This is in contrast to “refined grains” which contain only the endosperm following removal of the bran fraction by milling and/or decortication.

As used herein, the term “antioxidant” refers to a molecule capable of slowing or preventing the oxidation of other molecules. Oxidation is a chemical reaction that transfers electrons from a substance to an oxidizing agent. Oxidation reactions can produce free radicals, which start chain reactions that damage cells. Antioxidants terminate these chain reactions by removing free radical intermediates, and inhibit other oxidation reactions by being oxidized themselves. As a result, antioxidants are often reducing agents such as thiols, ascorbic acid or polyphenols. Antioxidants are found in varying amounts in foods such as vegetables, fruits, grain cereals, legumes and nuts. In addition to the use of antioxidants in medicine, for example to preventing diseases such as cancer and coronary heart disease, these compounds are also used as preservatives in food.

As used herein, the term “decorticate” or “decortication” refers to the process of removing the outer surface, bark, husk, membrane, or fibrous cover of an organ or structure. In many grains (including sorghum) the outer hull must be removed by decortication prior to processing.

As used herein, the term “cocoa” or “cocoa powder” refers to a powder produced by roasting and grinding cocoa beans. The resulting chocolate liquor is then subjected to strong hydraulic pressure to remove some of the fat or “cocoa butter.” “Cocoa” or “cocoa powder” is recognized in the United States as a “breakfast cocoa” containing not less than 22% cocoa fat, “medium fat cocoa” containing between 14 and 18% cocoa fat, and “low fat cocoa” containing less than 10% to 12% cocoa fat.

As used herein, the term “cocoa-containing” refers to a foodstuff or food product that contains “cocoa” or “cocoa powder”.

As used herein, the term “cocoa extender” refers to materials that reduce or replace the amount of cocoa bean derived material in a “cocoa-containing” foodstuff. An ideal cocoa extender should have physical properties and attributes that nearly approximate cocoa bean derived materials including color, consistency, nutrients and flavor. Depending on the application, cocoa powder and cocoa extender may be combined in proportions ranging from 1:99 to 99:1. In some embodiments, mixtures containing equal amounts of cocoa and cocoa extender are useful in preparing a desired foodstuff. In other embodiments, a cocoa extender may be directly substituted for any part of, or to the total exclusion of, the cocoa powder in foodstuffs utilizing cocoa and/or chocolate.

As used herein the term “roast”, “roasted” or “roasting” refers to a cooking method that uses dry heat, including but not limited to an open flame, oven, or other heat source. The roasting process does more than impart the required color to sorghum bran. For example, roasting affects the development of taste or flavor characteristics of the sorghum bran. It is not necessary that the roasting process impart chocolate or chocolate-like flavor to the roasted sorghum bran. However, it is imperative that the roasting process does not develop taste or flavor characteristics in the roasted sorghum bran which are inimical to chocolate flavor or which are otherwise so pronounced as to impart distinctly non-chocolate flavor or other undesired flavor in any products with which the roasted material may be used. Sorghum bran may be roasted in the manner described herein and develop rich chocolate brown color without developing any taste or flavor characteristics inimical with chocolate flavor or any other undesired flavor or physical property.

As used herein, the term “fiber” or “dietary fiber” refers to the indigestible portion of plant foods such as fruits, vegetables, nuts and grains. Dietary fiber consists largely of polysaccharides such as cellulose and can be soluble or insoluble. Soluble fiber absorbs water as it passes through the body and becomes a gelatinous substance; insoluble fiber passes through the body largely unchanged. Food sources of dietary fiber are often divided according to whether they provide predominantly soluble or insoluble fiber. Both types of fiber are present in plant foods with varying degrees of each according to a plant's characteristics. Thus, while all plants contain some fiber, plants with high fiber concentrations are generally the most practical source. Fiber-rich plants can be eaten directly or as supplements in fiber-rich processed foods. High-fiber diets have been reported to reduce levels of diseases, including colon cancer, coronary heart disease and diabetes.

As used herein, the term “gluten” refers to a composite of the proteins gliadin and glutenin, which are conjoined with starch in the endosperms of some grass-related grains, including wheat, rye and barley. Gliadin and glutenin compose about 80% of the protein contained in wheat seed. Being insoluble in water, they can be purified by washing away the associated starch. Gluten is an important source of nutritional protein worldwide, both in foods prepared directly from sources containing it, and as an additive to foods otherwise low in protein. Although wheat supplies much of the world's dietary protein and food supply, as much as 0.5% to 1% of the population of the United States has celiac disease, a condition which results from an inappropriate immune system response to gluten. The manifestations of celiac disease range from no symptoms to malabsorption of nutrients with involvement of multiple organ systems. The only effective treatment is a lifelong gluten-free diet; a diet completely free of ingredients derived from gluten-containing cereals: wheat, barley and rye, as well as the use of gluten as a food additive in the form of a flavoring, stabilizing or thickening agent. In addition to celiac disease, a gluten-free diet is recommended for the treatment of individuals with wheat allergies.

As used herein, the term “food product” or “foodstuff” refers to a substance that can be used or prepared for use as food, such as, for example those prepared from the starchy grains of cereal grasses. Specific examples of foodstuffs include, but are not limited to beverages, baked goods (including but not limited to brownies and breads), dairy products (including but not limited to ice cream, yogurt and egg nog), tapioca, candies, confections, coatings, syrups and the like.

As used herein, the term “nutraceutical” or “functional food” refers to a foodstuff, or extract thereof, that imparts physiological benefits and/or reduces the risk of chronic disease beyond basic nutritional functions.

As used herein, the term “grade” or “color grade” a position in a scale of ranks or qualities. For example, “color grade” may refer to the extent or degree to which the color of a foodstuff has been altered or enhanced in proportion to the amount of a pigment-containing compound (such as sorghum bran or sorghum whole grain) has been added to the foodstuff.

As used herein, the term “colorant” or “pigment” refers to a substance that modifies the perceived color of an object or imparts color to an otherwise colorless object. A “natural colorant” or “natural pigment” refers to a colorant or pigment that is synthesized and accumulated in, or excreted from, a living or deal cell of a plant, animal fungi or microorganism. These include compounds isolated from cells that are structurally modified to alter color stability, solubility or intensity. Such modifications include colorants or pigments whose synthesis is engineered in genetically transformed organisms. A “synthetic colorant” refers to an organic or inorganic colorant or pigment that is created artificially. The stability of synthetic colorants is affected by light, heat, pH, and reducing agents, although natural colorants generally have low stability compared to synthetic colorants. In the United States FD&C numbers are used to identify synthetic colorants approved for use in foods, drugs and cosmetics. Allura red AC (FD&C Red No. 40) is a commonly used red odorless food coloring dye added to a variety of products such as gelatin, puddings, dairy products, confections and beverages. Erythrosine (FD&C Red No. 3) is a reddish-pink synthetic dye that is most popularly used as a food-coloring agent in, for example, maraschino cherries.

### BRIEF DESCRIPTION OF THE DRAWINGS

Table 1 depicts the base formula of ingredients for analysis of cocoa substitution with high tannin sorghum bran in brownies. Formulations include replacing 0%, 50% and 25% by weight (grams) of the cocoa component with high tannin sorghum bran.

Table 2 depicts a brownie recipe that uses only (Hershey's) cocoa. Brownies were baked for 25 minutes at 350° C.

Table 3 depicts a brownie recipe using cocoa alone (0% substitution), an equal amount of cocoa and sorghum bran (50% substitution), or three times more cocoa than sorghum bran (25% substitution). Brownies were baked for 20 minutes at 325° C. The weight, volume and color of each brownie was measured after baking.

Table 4 depicts a brownie recipe using only (Hershey's) cocoa. Brownies were baked for 18-22 minutes at 325° C. The weight of each brownie was measured before and after baking.

Table 5 depicts a brownie recipe using cocoa alone (0% substitution), sorghum bran alone (100% substitution), an equal amount of cocoa and sorghum bran (50% substitution), or approximately three times more cocoa than sorghum bran (25% substitution). Brownies were baked for 18 minutes at 325° F. The weight of each brownie was measured before and after baking.

Table 6 depicts various preparation conditions for high tannin sorghum bran. The bran fraction following 10% or 20% decortication is roasted at either 140° C. or 200° C. for 10 or 20 minutes. The moisture content (% moisture) of the bran fraction after 20 minutes of roasting and the fructose concentration (% fructose at 50% moisture) are also recorded. A designation of 10/140/20/50/3, for example, indicates that 10% decorticated bran was roasted at 140° C. for 20 minutes, resulting in a moisture content of 50% and 3% fructose.

Table 7 depicts a brownie recipe using sorghum bran alone (100% substitution), an equal amount of cocoa and sorghum bran (50% substitution), or three times more cocoa than sorghum bran (25% substitution). Brownies with 25% substitution of cocoa with sorghum bran were also examined using either 10/140/20/50/3 treated bran or 20/140/20/35 treated bran (as described in Table 6). Brownies with 50% substitution of cocoa with sorghum bran were examined using 20/140/20/35 treated bran. Brownies were baked for 18 minutes at 325° F. The weight of each brownie was measured before and after baking.

Table 8 depicts a brownie recipe using a cocoa alone control (0% substitution), 25% substitution of cocoa with sorghum bran using 10/140/20/50/3 treated bran and 20/140/20/35 treated bran (as described in Table 6, and an equal amount of cocoa and sorghum bran (50% substitution) using 20/140/20/35 treated bran. Brownies were baked for 18 minutes at 325° F. The weight of each brownie was measured before and after baking.

### DETAILED DESCRIPTION OF THE INVENTION

The present invention relates generally to a formulation comprising from a desired amount of cocoa and a desired amount of a sorghum bran-based cocoa extender. In further embodiments, this invention relates to methods of preparing a foodstuff comprising a sorghum bran-based cocoa extender.

### I. Cocoa

Cocoa and its products (including chocolate) are used worldwide. Cocoa is produced by the process of roasting and grinding fermented cocoa beans into a thick creamy paste, known as chocolate liquor or cocoa paste. The resulting chocolate liquor is then subjected to strong hydraulic pressure to remove at least a portion of the fat content, known as cocoa butter. Cocoa contains large amounts of antioxidants such and polyphenols as well as magnesium, iron, chromium, vitamin C and zinc. According to research at Cornell University, cocoa powder has nearly twice the antioxidants of red wine, and up to three times the antioxidants found in green tea.

### II. Cocoa Extenders

Cocoa extenders are commonly used in the food production industry as a means of reducing the amount of cocoa or cocoa powder required for a variety of food products. A cocoa extender should exhibit physical and chemical properties that approximate those of cocoa bean derived materials as closely as possible, such as for example color, consistency, nutrient concentration and flavor, while also being readily available and inexpensive. Depending on the application, cocoa powder and cocoa extender may be combined in proportions ranging from 1:99 to 99:1. In some embodiments, mixtures containing equal amounts of cocoa and cocoa extender are useful in preparing a desired foodstuff. Cocoa extenders currently used in the food industry include, among others, roasted malted barley, carob fiber and chicory root. These products are relatively inexpensive, but some of have an off-flavor or are not widely available. Sorghum bran has excellent potential for production, making it inexpensive and without off-flavor. It can be finely ground. The tannin and black sorghums can be decorticated abrasively with common equipment to produce 10 to 20% yields of bran. The remainder of the kernel is mostly endosperm and can be used in feeds, alcohol production and pet foods.

### III. Experimental

In one embodiment, the present invention contemplates the use of bran from the decortication of tannin sorghum and black sorghum as a cocoa extender in food. The usage tannin sorghum and black sorghum bran as a cocoa extender represents several advantages in baking applications as compared to conventional cocoa extenders. Such advantages of sorghum bran include (but are not limited to) a natural color similar to cocoa, antioxidants and procyanidin levels similar to those found in cocoa or chocolate, widely available and inexpensive, high content of insoluble dietary fiber and mild flavor.

In some embodiments, commercially available sorghum hybrids are grown, the grain is cleaned and decorticated to remove from 10-20% of the initial weight followed by cleaning of the bran fraction to remove whole grain and grits, and then fine grinding the bran fraction to desirable particle sizes. These methods already exist in the literature and proper equipment to produce the same particle sizes as cocoa are in general use.

a) Color

The distinctive color of many sorghum species is determined by the presence of pigmented testa layer that contains tannins. Grain color is not necessarily a reliable indicator of the presence or absence of tannins; in fact sorghum grains that contain a pigmented testa may not be visually distinguishable from those that lack a pigmented testa. Sorghum species without a pigmented testa layer may exhibit a variety of characteristic colors due to the presence of non-tannin compounds that absorb light. For example, while tannin sorghum contains a pigmented testa, black sorghum may or may not contain a pigmented testa. However, black sorghum that lacks a pigmented testa still exhibit a blackish/brown color (i.e. chocolate color) due to the presence of non-tannin materials.

In one embodiment of the present invention, bran obtained from tannin sorghum and black sorghum has a color similar to those of cocoa. In some embodiments, the color of the sorghum bran permits its use as a cocoa extender raw, thereby eliminating the need for a roasting process.

i) Roasting

Alternatively, in other embodiments the sorghum bran may be roasted to improve both color and flavor, thereby permitting even greater substitution. In some embodiments, different roasting times and/or temperatures provide different colors to the bran, depending on the final cocoa application. In some embodiments roasting also alters and/or enhances the flavor of the bran such that and greater substitution is possible without affecting the taste. In further embodiments, varying the types and concentrations of sorghum used, including mixing bran from different sorghum sources may further enhance flavor, color and the level of substitution possible. Roasting of sorghum bran may be achieved using a variety of heat conduction means, such as a microionizer, conventional oven, fluidized bed or conduction oven.

Tables 2 and 4 illustrate brownie recipes that use cocoa only; that is they do not substitute sorghum bran-based cocoa extender for a percentage of the total amount of cocoa used.

Tables 3 and 5 illustrate brownie recipes using cocoa alone (0% substitution), an equal amount of cocoa and sorghum bran (50% substitution), or three times more cocoa than sorghum bran (25% substitution). Brownies were baked for 20 minutes at 325° C. The weight, volume and color of each brownie was measured after baking. Starting with approximately 25 grams of dough per brownie prior to baking, the weight of each brownie after baking was approximately 23-24 grams. The color and taste characteristics of brownies resulting from using an equal amount of cocoa and sorghum bran (50% substitution) and three times more cocoa than sorghum bran (25% substitution) were similar to those using cocoa alone (0% substitution).

Table 6 illustrates experiments to determine the conditions for roasting high tannin sorghum bran. Following 10% or 20% decortication, a 25-gram sample of the bran fraction is mixed with water (and fructose, depending of the treatment) and roasted in a convection oven at 140° C. or 200° C. for 10 or 20 minutes. Under these conditions the moisture content of the bran fraction is approximately 50% and the fructose concentration (if added) is approximately 3%. Results indicate that lighter colored bran was obtained with roasting times of 10-15 minutes at 400° F., while darker colored bran was obtained with roasting times of 10-20 minutes at 450° F. In related experiments, 25 grams of 16% decorticated bran (approximate moisture content 13%) was ground, sifted through a −20 mesh and mixed with water (10, 15, or 25 milliliters) prior to roasting at 140° C. for 15 minutes. Results indicate that bran mixed with 10 milliliters of water produced a good aroma and reddish color after roasting, while mixing the bran with 15 milliliters of water also resulted in bran with a good aroma and a darker reddish color.

Tables 7 and 8 illustrate brownie recipes using sorghum bran alone (100% substitution), an equal amount of cocoa and sorghum bran (50% substitution), or three times more cocoa than sorghum bran (25% substitution). To determine the effect on brownie color and flavor the bran fraction was roasted prior to baking under the conditions outlined in Table 6. Results indicate that 25% substitution of cocoa with sorghum bran did not result in greater moisture loss in the final product as compared to control brownies (0% substitution) or brownies containing Givaudan flavor. Starting with approximately 25 grams of dough per brownie prior to baking, the weight of each brownie after baking was approximately 23-24 grams. The color and taste characteristics of brownies resulting from 25% fine bran, 50% substitution using 20/140/20/35 treated bran, 0% substitution (control), 25% substitution using 20/140/20/35 treated bran and 10/140/20/50/3 treated bran were recorded. Brownies resulting from 25% substitution using 20/140/20/35 treated bran and 10/140/20/50/3 treated bran exhibited a slightly darker brown color than brownies resulting from 50% substitution using 20/140/20/35 treated bran. Brownies resulting from 25% fine bran substitution exhibited the darkest brown color, similar to the color of unsubstituted control brownies.

b) Mild flavor

While some cocoa extenders, such as black malt barley, have strong flavors and aromas that prevent high levels of substitution without affecting overall taste, sorghum bran has a mild (and sometime sweet) flavor that is easily masked by cocoa. Due to its mild flavor, described in some instances as neutral and/or slightly sweet, sorghum bran may be substituted for cocoa at higher concentrations than other cocoa extenders without contributing an off-flavor to the resulting foodstuff. The ability of sorghum to absorb flavors without impairing taste allows it to be adapted to a variety of dishes. In some embodiments, chocolate flavor may be incorporated into the sorghum bran for certain products, thus drastically reducing or eliminating the need for cocoa.

c) Health Benefits

In some embodiments, the use of sorghum bran as a cocoa extender contributes a variety of health benefits to a foodstuff. In some embodiments, such health benefits equal or surpass those associated with cocoa itself.

In addition to its color, the elevated tannin levels of sorghum provide antioxidants and procyanidins at concentrations similar to those found in chocolate and cocoa (Rooney and Waniska). Such similarity in characteristics between cocoa and sorghum is further evidence in support of the potential for sorghum bran to serve as a cocoa extender. Data suggest that sorghum tannin brans have many advantages over these common substitutes for cocoa in baking and other applications as colorants of natural source.

Sorghum is very high in fiber, iron and protein; with the majority of the nutrients retained in the grain's outer hull. Sorghum bran includes high levels of dietary fiber, the majority of which is insoluble fiber. Experimental results demonstrate the efficacy of sorghum bran in reducing colon cancer in lab rats induced to have cancer. In some embodiments, since the starches in sorghum bran are digested slowly in the body, sorghum bran may be a component of a healthy dies for individuals with diabetes such as type II diabetes. In some embodiments, sorghum bran substitution slows the digestion of starches in foodstuffs. In some embodiments, substitution with sorghum bran improves foodstuffs for type-II diabetics because the foodstuffs are digested more slowly. In other embodiments, foodstuffs that contain sorghum bran may be a component of a healthy diet for individuals requiring a gluten-free diet; including individuals with celiac disease or wheat allergies.

d) Cost

Sorghum is extremely drought tolerant, and therefore well suited to growth in arid and dry areas making it a very stable source of nutrition. Due to its capacity for high yields and the fact that it is largely unexploited as a food source for humans, sorghum bran has a high potential as a cost-effective food extender without exerting additional strain on existing human food sources and/or their areas of cultivation. Furthermore, the sorghum species of plants is currently receiving significant attention as a potential source for renewable biofuels, thereby further reinforcing its likelihood of being actively cultivated and therefore readily available.

e) Non-Cocoa Applications

In related embodiments, sorghum bran can be incorporated into a variety of baked products, including but not limited to products that exhibit a natural dark or brown color. Such products include high fiber, high antioxidant foodstuffs such as bread. In other embodiments, sorghum bran may be incorporated as a supplement for foodstuffs that do not naturally contain significant levels of fiber and antioxidants. In some embodiments, elevated tannin levels in sorghum may be utilized to contribute antifungal and/or antibacterial properties to a foodstuff, including but not limited to cocoa containing foodstuffs. In some embodiments, a natural antifungal and/or antibacterial activity could reduce or eliminate the need for other chemical preservatives. Such embodiments may be useful in the preparation of foodstuffs with prolonged shelf life, enhanced flavor and/or comprising fewer unhealthy additives.

### IV. Flavonoid Content of Sorghum

Flavonoids are of much interest in due to their antioxidant potential and health benefits. Many flavonoids have been identified over the years (Dykes and Rooney 2006) but information on their quantities is limited. Flavonoids are plant secondary metabolites that represent the single most widely occurring group of phenolic phytochemicals. These non-nutrient compounds act as in vitro antioxidants (Awika et al 2003) and some are more potent than vitamins found in other plants (Rhodes and Price 1997, Harborne & Williams 2000). Phenolic compounds are a desirable component of nutraceuticals and functional foods, particularly as dietary antioxidants. Sorghum contains a wide variety of flavonoids including, 3-deoxyanthocyanins, flavones (such as apigenin and luteolin), and flavanones (such as eriodictyol and naringenin). Although all sorghums contain phenolic compounds, the genotype and the environmental factors under which the grain matures influence the amount present in any particular cultivar. Sorghums are a good source of flavonoids with several attractive advantages for their use. One such advantage is that sorghum is dry and therefore easy to process into shelf-stable concentrates that store for long periods of time. Sorghum is the only dietary source of 3-deoxyanthocyanins (Wu and Prior 2005).

Since genetics affect the type and level of flavonoids in sorghum, the flavonoid content in non-tannin sorghum of varying phenotypes were compared to those from common sources using HPLC-DAD. Ground sorghum samples were extracted in 1% HCl/methanol for 2 hours at room temperature. The extracts were immediately analyzed for 3-deoxyanthocyanin and flavone composition. The acidified methanol extracts were then placed in a water bath at 80° C. for 90 minutes to hydrolyze the flavanone glycosides to their aglycones prior to flavanone analysis. Flavonoid composition was determined using HPLC-DAD. 3-Deoxyanthocyanins, flavones, and flavanones were monitored at 485, 340, and 280 nm, respectively.

In some embodiments, all sorghum varieties had flavonoids including those with a white pericarp. In some embodiments, sorghum flavones and flavanones are located in the pericarp, where they are concentrated 4-9-fold in the bran. Some sorghums contain high levels of flavanones (1428-1780 μg/g, fresh wt.), which are comparable, if not higher, to those found in citrus (115-574 μg/g, fresh wt.). In other embodiments, the major flavonoids in black pericarp sorghums are the unique 3-deoxyanthocyanins with levels of 676-1054 μg/g (fresh wt.); black sorghum had higher levels of 3-deoxyanthocyanins than all other sorghums examined. In other embodiments, red, lemon-yellow and black sorghums with secondary purple plant color also have 3-deoxyanthocyanins, but their levels are lower than the black pericarp sorghums (13-187 μg/g, fresh wt.). In still other embodiments, sorghums with secondary tan plant color, including those with a white pericarp, contain high levels of flavones (63-386 μg/g, fresh wt.), which are significantly higher than those found in vegetables (9-104 μg/g, fresh wt.). In another embodiment, flavone levels in the bran and whole grain fraction of red sorghum with tan secondary color were higher than those in vegetables. White, lemon-yellow and red sorghums with tan secondary plant color did not have detectable 3-deoxyanthocyanin levels. Sorghums with a lemon-yellow pericarp, with either tan or purple secondary colors, had the highest levels of flavanones compared to citrus on a fresh weight basis. These levels were concentrated up to nine-fold in the bran.

Flavonoid profiles of twenty-four varieties of whole grain sorghum with and without a pigmented testa were also analyzed for total phenols, condensed tannins, flavan-4-ol, anthocyanin content and antioxidant activity. Total phenols of acidified methanol extracts were measured using the modified Folin-Ciocalteu method of Kaluza et al. (1980). Condensed tannins were measured using the modified Vanillin/HCl assay as described by Price et al. (1978). Flavan-4-ol content was measured using the modified method of Govindarajan and Mathew et al. (1965) as described by Gous et al. (1989). Anthocyanins content was measured using the method of Fuleki and Francis (1969). Antioxidants activity of sorghum extracts were measured in vitro by DPPH and ABTS as described by Awika et al. (2003). 3-Deoxyanthocyanins, flavones and flavanones were separated and quantified using HPLC-PDA Dykes et al. (2008).

In one embodiment, varying phenol levels suggest that phenol content does not depend on the pericarp color of the sorghum and the presence of pigmented testa does not affect flavonoid concentration or profile. In one embodiment, the bran from decorticated sorghums contains significantly more concentrated levels of phenol. In some embodiments, total phenol levels varied among the different types of sorghum, ranging from 3-14 mg Gallic acid equivalent (GAE)/g. In one embodiment, condensed tannins were highest in type-III followed by type-II sorghums and ranged from 0.03-30 mg catechin equivalent (CE)/g. In one embodiment, red pericarp sorghums have the highest Flavan-4-ol compounds such as luteoforol and apiforol. In another embodiment, anthocyanin levels ranged from 21-143 abs/mL/g. In yet another embodiment, sorghums with the red turning to black pericarp had the highest antioxidant levels. Both ABTS and DPPH values strongly correlated with total phenols (r=0.926 and 0.847) and tannin levels (r=0.824 and 0.892). In one embodiment, the 3-deoxyanthocyanins were the main flavonoids in black pericarp sorghums, reaching 250 μg/g in whole grain black pericarp sorghum compared to 15 μg/g in white pericarp sorghums. In another embodiment, flavones such as apigenin and luteolin were detected in all sorghums investigated and ranged from 2-100 μg/g. Flavanones such as eriodictyol and naringenin determined ranged from 2-250 μg/g, with the least amounts found in white pericarp sorghum. In some embodiments, of tannin sorghums containing the special red turning to black pericarp enhance antioxidant levels.

Non-grain sorghum tissues, including sheaths, leaves and glumes are also contain flavonoids. A variety of grain and non-grain sorghum tissues were analyzed using HPLC-PDA to determine their phenolics, 3-deoxyanthocyanin, flavone and flavanone profiles. In one embodiment, 3-deoxyanthocyanins (luteolinidin, apigeninidin, 5-methoxyluteolinidin, 7-methoxyapigeninidin), flavones (luteolin and apigenin) and flavanones (naringenin and eriodictyol) were detected in the non-grain tissues of these sorghum varities. In one embodiment, non-grain sorghum tissues are a source for all classes of sorghum flavonoids. The phenolic profiles of sorghum grains and non-grain plant tissues of varying secondary plant colors were also examined.

After harvesting, leaves, sheaths and stalks were placed in liquid nitrogen, and freeze-dried. The dried glumes and grains were stored in the refrigerator at 80° C. All samples were ground through a 0.5 mm mesh cyclone mill (UDY Corp., Fort Collins, Colo.) prior to extraction. Samples were extracted in 1% HCl/methanol for 2 hours at room temperature while shaking. To remove the chlorophyll from the leaves and sheath extracts, petroleum ether was added to the supernatant and mixed. The supernatants were immediately analyzed for 3-deoxyanthocyanins and flavones. Prior to flavanone analysis, the supernatants were placed in a water bath at 80° C. for 90 min. to hydrolyze flavanone glycosides to their aglycones (Dykes 2008). Flavonoid profiles were obtained using HPLC-PDA; 3-Deoxyanthocyanins, flavones and flavanones were detected at 485, 340 and 280 nm, respectively. Flavonoids were identified based on commercial standards' retention times and UV-Vis spectra and they were quantified using standard curves for each respective standard.

In one embodiment, with the exception of the stalks, the non-grain tissues of sorghum contain flavonoids. The levels of flavonoids in these non-grain sorghum tissues were similar to common dietary sources. In one embodiment, the glumes had 600 times more 3-deoxyanthocyanins than the grain. In another embodiment, intensely pigmented leaves, sheaths and glumes had high levels of 3-deoxyanthocyanins. 3-Deoxyanthocyanin levels (luteolinidin, apigeninidin, 5-methoxyluteolinidin and 7-methoxyapigeninidin) were detected in the leaves, glumes, sheaths and grains. In one embodiment, color intensity of the non-grain tissues was related to 3-deoxyanthocyanin content but was not related to the content of flavones and flavanones. In another embodiment, flavone levels were detected in the leaves, glumes, sheaths and grains. Apigenin and luteolin were detected in the sheaths, with apigenin being the predominant flavone. In yet another embodiment, the glumes and leaves had 161 and 77 times more flavones respectively than their respective grain. In yet another embodiment, overall the sheaths, glumes and leaves of red secondary plant color sorghum varieties were higher in apigenin than luteolin. In one embodiment, flavanones (naringenin and eriodictyol) were also detected in the leaves, glumes, sheaths and grains.

In one embodiment, sorghum flavonoid levels are ranked according to the following ascending order of abundance in different tissues: 3-Deoxyanthocyanins: Glumes>sheaths>leaves; Flavones: Glumes>leaves>sheaths; Flavanones: Glumes>grains>leaves>sheaths.

In yet another embodiment, sorghum biomass by-product of ethanol production is a source of raw material for flavonoid compounds. In another embodiment, flavonoids are a valuable co-product of biomass energy production.

### V. Color Stability of Sorghum Bran Extracts Under Different pH and Temperatures

The effect of temperature and pH on color stability of sorghum bran extracts was compared with synthetic colorants Red No. 3 and No. 40. Natural colorants generally have low stability compared to synthetic colorants. Black sorghums have high levels of 3-deoxyanthocyanins compared to red and brown sorghums. 3-deoxyanthocyanins present in sorghum are more stable at pH values near neutrality than the common anthocyanins. 3-deoxyanthocyanins extracted from black sorghum and black tannin sorghum brans were stored for 13 weeks for comparison with synthetic colorants Red No. 3 and Red No. 40 at different pH and temperatures.

Black sorghum and black tannin sorghum bran were extracted with acidified ethanol and concentrated to complete dryness. Dry extracts were reconstituted in 70% ethanol to obtain a concentration of 5 mg/mL and stored for specified periods. Red No. 3 and Red No. 40 were reconstituted in 70% ethanol. Samples were stored in the dark. Measurements for pH were performed at 0 hours, 1 day, and every 7 days for 13 weeks. One set was stored for a year. pH was adjusted and tested from 1 to 11 using 0.01N HCl and 0.01N NaOH; temperature were −8° C., 4° C., 25° C. and 50° C. Analyses were done in triplicate. Changes in color attributes of black sorghum, black tannin sorghum, Red No. 3 and Red No. 4 were measured at 25° C. and 50° C. after 1 week, 13 weeks and 12 months at a concentration of 5 mg/ml at pH 2. Hue values were measured with a Minolta colorimeter at pH from 1 to 11 and temperatures of 8° C., 4° C., 25° C. and 50° C. Hue is expressed in degrees (0°=red, 90°=yellow, 180°=green, 270°=blue). Chroma is a measure of the intensity or saturation (0=lowest intensity).

In some embodiments, the color of black sorghum and black tannin sorghum extracts were stable throughout the pH range. Black tannin sorghum was more stable to pH conditions over time than black sorghum. In one embodiment, black sorghum exhibits hues (orange) similar to Red No. 3. In one embodiment, black tannin sorghum exhibits hues (orange-red) similar to Red No. 40. Hue values of the black tannin sorghum bran extracts were stable at −8° C., 4° C., and 25° C. In another embodiment, instability at high temperature occurs due to anthocyanins forming brown products. In yet another embodiment, black tannin sorghum was comparable to Red No. 40, with hue values (orange color) similar at all temperatures for 13 weeks. Red No. 3 had more variation with poor stability. In one embodiment, the hue of black tannin sorghum bran extracts was more stable over time at all pH than those from black sorghum. In another embodiment, sorghum bran extracts retained their color at all pH. In one embodiment, the black tannin extracts were similar to synthetic Red No. 40. The orange colored extracts of black sorghum were similar to synthetic Red No. 3. In one embodiment, the color of both sorghum bran extracts and Red #40 were stable at all temperatures except 50° C., while Red No. 3 was unstable over time. In another embodiment, the condensed tannins present in black tannin extracts enhance their stability. In some embodiments, the black sorghum and black tannin sorghum bran extracts have excellent potential for use in the food industry as natural colorants. In other embodiments, black sorghum pigments can be manipulated to produce different lightness, chroma, and hue values. In one embodiment, black tannin sorghum had the best color stability. In another embodiment, black sorghum brans with and without tannins are excellent sources of natural food colorants.

### VI. Whole Non-Wheat Flours

A major contributor to the obesity, diabetes, and impaired glucose tolerance and insulin resistance epidemic in the United States is the increased intake of refined carbohydrates. (Gross et al. 2004). Dietary fiber and omega-3 fatty acids are efficient in the prevention and management of diabetes (Esmailzadeh et al. 2005; Liu et al, 2000). Whole grains are richer in fiber, vitamins, minerals, phenolic compounds, phytoestrogens and other constituents (Slavin et al., 1999). Along with leavened bread, tortillas are North America's leading staple bread (Baggs 2007), and are excellent carriers of higher amounts of fiber and other nutraceutical ingredients.

The effect of incorporating nutraceutical ingredients on flour tortilla quality was examined as a healthy alternative to refined wheat flour tortillas. Four flour tortilla formulations with ground flaxseed (5% in all treatments), sorghum bran (5%), oat flour (20%) and buckwheat flour (10%) were prepared using a hot-press method. These grains carry a wide array of other nutritional components aside from dietary fiber including antioxidants. Physical properties, texture and shelf-stability were evaluated. Tortillas had similar diameter (15.9+0.4 cm) and thickness (0.23+0.03 cm), and had darker colors especially with the addition of sorghum bran and buckwheat flour. All tortillas were shelf-stable, retaining flexibility after 16 days of storage. Texture analysis reflected the decrease in tortilla flexibility during storage, but was not significantly different among treatments. Dietary fiber is increased with flaxseed, sorghum bran, whole white wheat, oat and buckwheat flours. Flax and sorghum are also excellent sources of omega-3 and antioxidants, respectively. Oat flour provides beta-glucans, and buckwheat has D-chiro-inositol that can reduce serum glucose concentrations.

Control tortillas were prepared with a standard formula: 500 grams whole white wheat flour, 30 grams all purpose shortening, 7.5 grams salt, 2.5 grams sodium stearoyl lactylate, 2 grams potassium sorbate, 2 grams sodium propionate, 3 grams sodium bicarbonate, 2.9 grams sodium aluminum sulfate, 1.65 grams encapsulated fumaric acid and 270 grams distilled water. In three formulations the white wheat flour was substituted with 5% sorghum bran, 20% oat flour and 10% buckwheat flour, while a fourth formulation contained 5% of each ingredient. All formulations contained 5% flaxseed. To compensate for reduced gluten, 3 grams of vital wheat gluten was added to formulations with sorghum bran, oat or buckwheat, and 8 grams for the multigrain formulation.

Tortillas were produced using the method described by Bello et al (1991). Tortillas were packed in 1 ml polyethylene plastic bags and stored at 22° C. for 16 days. Diameter, opacity, thickness and weight were evaluated 1 day after the tortillas were processed. Subjective rollability measurements were done to evaluate shelf stability at 4, 8, 12, and 16 days of storage. Rollability scores (RS) ranged from 1 (breaks when rolled, “bad”) to 5 (easy to roll without breaking, “best”). Texture was evaluated using the TA.XT2i Texture Analyzer (Texture Technologies Corp., Scarsdale, N.Y./Stable Micro Systems, Godalming, Surrey, UK) using a 3D extensibility method. Compression modulus and rupture force values were obtained. The Quality Index (QI) was calculated as follows: QI=(Opacity)*(Specific volume)*(Rollability score) at day 12 (Cepeda et al., 2000). QI values above 450 indicate tortillas have good to excellent storage stability, opacity and diameter.

In one embodiment, physical properties of tortillas were not significantly different among formulations. The added fiber decreased specific volume, which approximates fluffiness—refined flour tortillas have about 1.6 cm3/g. In one embodiment, tortillas with the greatest wheat-substitution (O20%+F5%) had the lowest overall quality. In one embodiment, substituting white wheat with other grains decreased the lightness value of the tortillas. In another embodiment, sorghum bran isolated from an antioxidant-rich brown variety, resulted in the greatest change in color, while oat flour had the least effect. In another embodiment, tortillas with 20% oat and 5% flax had the shortest overall shelf stability. All treatments had acceptable tortillas (score>3) after 2 weeks of storage. In yet another embodiment, deformation modulus increased with storage time, indicating that the tortillas became easier to break. However, this was not significantly affected by the substitution of other grains. In a further embodiment, addition of whole non-wheat flours improved the nutritional profile of flour tortillas. In one embodiment, tortillas had about 3.5 grams dietary fiber and 0.29 grams omega-3 fatty acids per tortilla, making them a good option for health conscious consumers. In another embodiment, the added grains produced darker-colored tortillas; a color often associated with healthier foods. In yet another embodiment, tortillas from all treatments were still extensible after 2 weeks of storage.

In one embodiment, the combination of CMC and amylase significantly improved the rollability and acceptability of whole white wheat tortillas containing 5% sorghum bran and 5% ground flaxseed (Alviola & Rooney, IFT08 Poster 174-12). In other embodiments, the use of CMC and amylase further improves the acceptability of these healthy tortillas.

We claim:

1. A formulation comprising an amount by weight of cocoa and an amount by weight of a sorghum bran-based cocoa extender, wherein the bran fraction of said sorghum bran-based cocoa extender is from the group consisting of non-tannin sorghum, low tannin sorghum, high tannin sorghum, black sorghum, black tannin sorghum and mixtures thereof.

2. The formulation of claim 1, comprising from 75% to 50% by weight of cocoa and from 25% to 50% by weight of sorghum bran-based cocoa extender.

3. The formulation of claim 1, wherein said sorghum bran-based cocoa extender comprises a natural pigmentation.

4. The formulation of claim 3, wherein the grade of said pigmentation may be altered by roasting.

5. The formulation of claim 3, wherein said natural pigmentation enhances the color of a cocoa-containing foodstuff.

6. The formulation of claim 5, wherein the foodstuff is selected from the group consisting of cocoa, chocolate, chocolate coatings, chocolate fillings, cookies, puddings, breads, beverages, baked goods, brownies, dairy products, ice cream, yogurt, tapioca, egg nog, candies, confections, coatings and syrups.

7. The formulation of claim 1, wherein said sorghum bran-based cocoa extender is a source of dietary fiber.

8. The formulation of claim 7, wherein said dietary fiber is insoluble dietary fiber.

9. The formulation of claim 1, wherein said sorghum bran-based cocoa extender is a component of a gluten-free foodstuff.

10. A method of preparing a foodstuff comprising a sorghum bran-based cocoa extender comprising:
a) providing a sorghum grain;
b) removing the bran fraction from said sorghum grain;
c) grinding said bran fraction; and
d) adding the desired amount of said bran fraction to a cocoa-containing foodstuff, so as to create a sorghum bran-based cocoa extender.

11. The method of claim 10, wherein said sorghum grain is selected from the group consisting of non-tannin sorghum, low tannin sorghum, high tannin sorghum, black sorghum, black tannin sorghum and mixtures thereof.

12. The method of claim 10, wherein said bran fraction comprises a natural pigmentation.

13. The method of claim 10, wherein adding the desired amount of said bran fraction to a cocoa-containing foodstuff alters the color of said foodstuff.

14. The method of claim 10, further comprising prior to step c) the step of roasting the bran fraction to alter the grade of the pigment of said bran fraction.

15. The method of claim 14, wherein said bran fraction is roasted at a temperature between 140° C. to 200° C. for between 10 to 20 minutes.

16. The method of claim 10, wherein adding said bran fraction to a cocoa-containing foodstuff replaces an equivalent amount of cocoa in said foodstuff.

17. The method of claim 16, wherein from 25% to 50% by weight of cocoa is replaced by said bran fraction in a foodstuff.

18. The method of claim 12, wherein said natural pigmentation enhances the color of a cocoa-containing foodstuff.

19. The method of claim 18, wherein the foodstuff is selected from the group consisting of cocoa, chocolate, chocolate coatings, chocolate fillings, cookies, puddings, breads, beverages, baked goods, brownies, dairy products, ice cream, yogurt, tapioca, egg nog, candies, confections, coatings and syrups.

20. The method of claim 10, wherein said cocoa-containing foodstuff is a source of dietary fiber.

21. The method of claim 10, wherein said cocoa-containing foodstuff is gluten-free.

22. A method of preparing a foodstuff comprising a sorghum bran-based cocoa extender comprising:
a) providing:
i) a recipe for a cocoa-containing foodstuff specifying an amount of cocoa;
ii) ingredients for preparing said foodstuff, said ingredients comprising cocoa; and
iii) a bran fraction of sorghum grain;
b) replacing a portion of said amount of cocoa specified in said recipe with said bran fraction; and
c) preparing said cocoa-containing foodstuff.

23. The method of claim 22, wherein said ingredients further comprise flour.

24. The method of claim 23, wherein said foodstuff is a baked good.

25. The method of claim 22, wherein said foodstuff is a beverage.

26. The formulation of claim 1, comprising cocoa and sorghum bran-based cocoa extender combined in a proportion ranging from 1:99 to 99:1 by weight.

27. The method of claim 10, wherein the cocoa-containing foodstuff and the bran fraction are combined in a proportion ranging from 1:99 to 99:1 by weight.

28. The formulation of claim 5, wherein the foodstuff is a processed food.

29. The method of claim 18, wherein the foodstuff is a processed food.
